(19) United States
(12) Patent Application Publication
(10) Pub. No.: US 2024/0308894 A1
(43) Pub. Date: Sep. 19, 2024

(54) MODULAR METHOD FOR DELIVERY OF FRESH WATER TO COASTAL COMMUNITIES

(71) Applicant: Dehlsen Associates of the Pacific Limited, Santa barbara, CA (US)

(72) Inventors: James George Purnell Dehlsen, Aukland (NZ); Peter Damon Stricker, Santa Barbara, CA (US); Joseph E. Zuback, Camarillo, CA (US)

(21) Appl. No.: 18/606,961

(22) Filed: Mar. 15, 2024

Related U.S. Application Data
(60) Provisional application No. 63/452,479, filed on Mar. 16, 2023.

(51) Int. Cl. C02F 9/00; B01D 61/02; B01D 61/04; B01D 61/08; B01D 65/02; C02F 1/00; C02F 1/32; C02F 1/44; C02F 1/68; C02F 103/08

(52) U.S. Cl. CPC C02F 9/00; B01D 61/026; B01D 61/04; B01D 61/08; B01D 65/02; C02F 1/008; B01D 2313/243; B01D 2313/54; B01D 2313/701; B01D 2317/02; B01D 2317/06; B01D 2321/04; C02F 1/001; C02F 1/32; C02F 1/441; C02F 1/68; C02F 2103/08; C02F 2201/007; C02F 2209/006; C02F 2209/02; C02F 2209/03; C02F 2209/05; C02F 2209/11; C02F 2209/40; C02F 2209/42; C02F 2301/08; C02F 2303/04; C02F 2303/16

(57) ABSTRACT

A modular distributed desalination system including a desalination buoy interconnected to a landside post-treatment station. The desalination buoy further includes a dynamic ballast system, a reverse osmosis system, an integral media filter, and intake screen, and a brine diffuser system.

### REFERENCE TO RELATED APPLICATIONS

This application claims priority of U.S. Provisional Application Ser. No. 63/452,479 filed on Mar. 16, 2023 entitled MODULAR METHOD FOR DELIVERY OF FRESH WATER TO COASTAL COMMUNITIES having a common assignee and applicant with the present application, the disclosure of which is incorporated herein by reference.

### FIELD AND BACKGROUND OF THE INVENTION

Field A method for supplying a fresh water supply is provided for. The method for supplying a fresh water supply more particularly relates to the field of extracting and treating seawater so as to be able to deliver fresh water for coastal communities.

Description of the Related Art A reliable supply of fresh water in arid coastal communities is becoming increasingly challenging because of extended droughts driven in part by climate change. One method to increase the supply of fresh water is by increasing the importation of fresh water from other freshwater sources such as rivers, lakes, and reservoirs. One drawback of this method is that the availability of freshwater from such sources is entirely dependent upon rainfall and greatly reduced during extended drought conditions. Another drawback of this method is the cost to operate and maintain long-distance freshwater transport infrastructure, i.e. pipelines, pumps, operations, and maintenance.

Another method to increase the fresh water supply is by desalinating seawater with thermal or reverse osmosis desalination plants located onshore near the coast. One drawback of this method is that onshore desalination plants must comply with ocean environment requirements that increase costs and project delivery time. For example in California, the Claude “Bud” Lewis Carlsbad Desalination Plant project in Carlsbad, California began in 1993, but did not start operating until 22 years later in 2015, at a cost of $1 billion for production of 50 million gallons per day of fresh water. Lawsuits in opposition to the project because of concerns regarding the effect of ocean water intakes and brine discharges on the aquatic environment contributed to the project delay and cost. Another drawback of this method is that onshore desalination plants are typically built on expensive or sensitive coastal property that increases costs and project delivery time. Another example in California is the Monterey Bay project located in Marina, CA, which was opposed by environmental justice advocates who claimed that building the project in Marina would unfairly burden a historically underserved community. A further drawback is the potential for desalination plants to become disused and be “stranded assets” during extended periods of precipitation between drought periods.

Regions experiencing significant drought (or other interruptions to the regular water supply) require the prompt establishment of a substantial new water supply. Large, central desalination plants often require years of planning and permitting, along with the need for a substantial electric power supply. Generally, each plant is unique and requires a substantial engineering and construction effort to implement. Furthermore, high-capacity pipelines are required to draw seawater into the system and to discharge brine back to the ocean. The pooling of brine around the end of the brine discharge pipe can have adverse impacts on marine life in the vicinity and is a key hurdle in environmental permitting.

However, marine and barge-mounted desalination systems are becoming available, which can transit at sea, stationing in coastal areas in need of freshwater. Some of these have an on-board electric power generating systems and fuel supplies while others rely on power from the shore. Typically barge-type vessels are not suited for open-ocean conditions because of seaworthiness challenges caused by large waves and high winds impacting surface-borne vessels in the open-ocean. Most desalination systems on marine vessels are based on reverse osmosis (RO) membranes contained in tubular pressure vessels which are orientated horizontally to fit a horizontal spatial arrangement in the vessel. Often these RO systems are located on a deck above the waterline, which contributes to vessel instability by raising the vessels center of gravity, especially when the RO system is operation and full of water Ship-based systems require a crew to be available to operate the ship, even at moorage, in addition to the desalination system.

Furthermore, an RO surface vessel, such as a barge or a ship, may impose an undesirable view on the natural beauty of the coastline, which can be particularly undesirable if the vessel is moored in an area which is dependent on tourism. Marine surface vessels are also subject to extreme environmental forces of wind and waves, where pitch and roll in high seas can test survival. Vessels with a large surface profile are especially vulnerable to high winds.

Therefore, there is a need in the art for a modular method of delivering fresh water that solves the issues discussed above for thermal or reverse osmosis desalination plants located onshore near the coast and the issues discussed above for marine and barge-mounted desalination systems.

### SUMMARY OF THE INVENTION

The implementations disclosed herein provide a modular water desalinization system (MWDS) including at least one processing buoy having a container vessel with a plurality of compartments. An intake screen is connected through intake water piping to a water filter connected to each of the plurality of compartments providing filtered water to distribution water piping. A filtered water holding tank is connected to the distribution water piping. A plurality of water treatment systems, one of the plurality of water treatment systems supported in each of the plurality of compartments and includes a plurality of Reverse Osmosis (RO) membrane elements stored in vertically oriented RO vessels connected to the filtered water holding tank through treatment inlet water pipes, a brine discharge port connected to the RO vessels to discharge brine and outlet piping connected to the RO vessels to receive desalinated water. A high pressure pump is connected to the distribution pipes for water pressurization in the treatment inlet water pipes. A buoy controller is operably connected to the high pressure pump. The MWDS also includes at least one modular post treatment station having a plurality of stacked ring sections interconnected to form a housing. Post treatment equipment is housed within the housing and has inlet piping, the post treatment equipment producing post treated water. Distribution outlet piping is connected to the post treatment equipment for output of post treated water for use. A control system is connected to the buoy controller, the control system configured to instruct operation of the high pressure pump responsive to water demand. A water hose umbilical connects the outlet piping to the inlet piping. An electrical power umbilical having a power cable and connecting the control system to the buoy controller.

### BRIEF DESCRIPTION OF THE DRAWINGS

Various embodiments will become better understood with regard to the following description, appended claims and accompanying drawings wherein:

FIG. 1 is a schematic view of a modular distributed desalination system including a desalination buoy interconnected to a landside post-treatment station;

FIG. 2A is a perspective view of a desalination buoy showing internal components thereof;

FIG. 2B is a schematic view of a valve configuration;

FIG. 3A is a perspective view of a landside post-treatment station;

FIG. 3B is a perspective view of the landside post-treatment station of FIG. 3A showing internal components thereof;

FIG. 3C is a perspective view of the landside post-treatment station of FIG. 3A showing additional internal components thereof;

FIG. 3D is a top view of a plurality of landside post-treatment stations forming a building cluster;

FIG. 4 is a schematic view of the modular distributed desalination system of FIG. 1 showing internal components of the Supervisory Data Acquisition Control (SCADA) system that controls the desalination buoy and landside post-treatment station;

FIG. 5 is a perspective view of a desalination buoy showing the components of the dynamic ballast system of the desalination buoy;

FIG. 6A is a perspective view of an embodiment of the desalination buoy showing components of the reverse osmosis system of the desalination buoy;

FIG. 6B is a perspective view of an embodiment of the desalination buoy showing components of the reverse osmosis system of the desalination buoy;

FIG. 6C is a perspective view of an embodiment of the desalination buoy showing components of the reverse osmosis system of the desalination buoy;

FIG. 6D is a perspective view of a ship-mounted crane handling a reverse osmosis pressure vessel magazine of the reverse osmosis system of the desalination buoy;

FIG. 7A is a perspective view of an embodiment of the intake screen of the desalination buoy prior to the intake screen being wrapped around a middle portion of the buoy container vessel;

FIG. 7B is a perspective view of the intake screen being wrapped around the middle portion of the buoy container vessel;

FIG. 7C is a perspective view of an embodiment of the intake screen of the desalination buoy wrapped around a bottom portion of the buoy container vessel;

FIG. 8A is a perspective view of a desalination buoy showing the positions of major elements within the buoy;

FIG. 8B is a perspective view of a desalination buoy showing components of the integral media filter of the desalination buoy;

FIG. 8C is a perspective view of a desalination buoy showing components of the integral media filter of the desalination buoy;

FIG. 8D is a perspective view of a desalination buoy showing components of the integral media filter of the desalination buoy;

FIG. 9A is a perspective view of the brine diffuser system of the present disclosure;

FIG. 9B is a perspective view showing how the discharge thruster device of the brine diffuser system of the present disclosure follows an arc while ejecting brine;

FIG. 9C is a perspective view showing an embodiment of the discharge thruster device of the brine diffuser system utilizing a positioning motor to assist in adjusting the vertical position of the discharge thruster;

FIG. 9D is a perspective view showing how an embodiment of the discharge thruster device of the brine diffuser system follows vertical trajectories determined by a pivoting position of the nozzle while ejecting brine;

FIG. 9E is a perspective view showing an embodiment of the discharge thruster device of the brine diffuser system having two opposing nozzles with control valves determining binary flow direction while ejecting brine through one of the two opposing nozzles; and

FIG. 9F is a perspective view showing an embodiment of the discharge thruster device of the brine diffuser system utilizing a marine thruster to accelerate through the surrounding seawater.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings, wherein like numbers indicate the same or corresponding elements throughout the views. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, it should be understood that unless otherwise specified or required by context, any explicit or implicit ordering of steps performed in the execution of a method does not imply that those steps must be performed in the order presented but instead may be performed in a different order or in parallel.

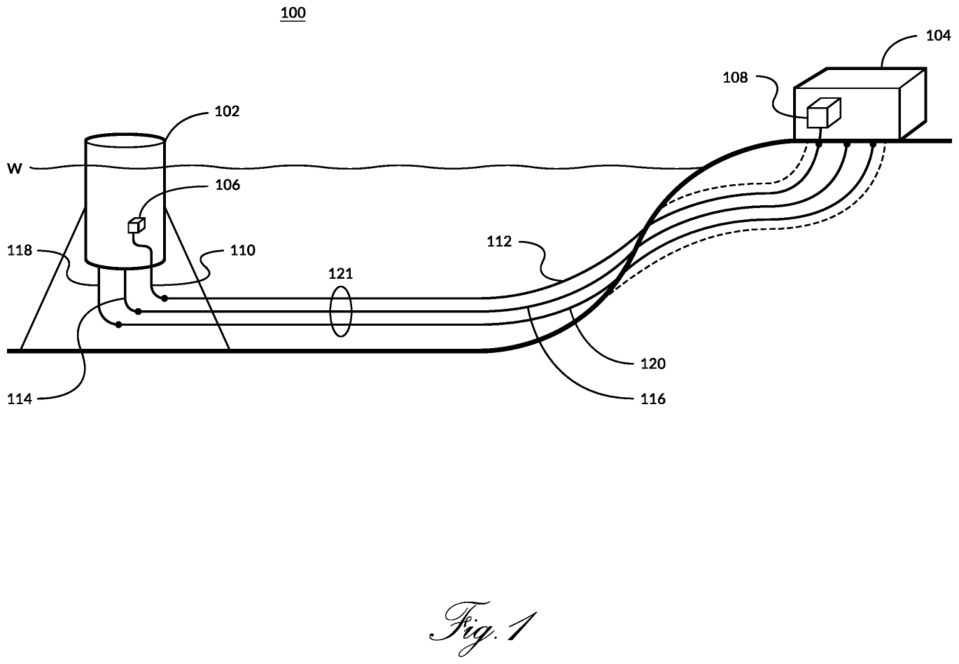

FIG. 1 shows the modular distributed desalination system 100 of the present disclosure. System 100 generally consists of at least one desalination buoy 102 and a modular post-treatment station 104. In use, a first portion of buoy 102 will lie above the waterline W and a second portion of the buoy 102 will lie below the waterline W. The system 100 further consists of a buoy controller 106 secured to at least one buoy 102. In embodiments wherein there is more than one buoy 102 present within system 100, each buoy will include its own buoy controller 106. Buoy controller 106 is connected to a control system 108 located on or within the station 104. The buoy controller 106 and control system 108 are elements to cooperatively form a Supervisory Data Acquisition and Control (SCADA) system 172 that will be discussed in detail below. In one embodiment, the buoy controller 106 is connected to the control system 108 through a control signal umbilical 110 and signal cables 112. In other embodiments, the buoy controller 106 is connected to the control system 108 through other connection means such as cellular or satellite connection capabilities. Buoy controller 106 may also communicate locally with devices carried by operations and maintenance personnel when servicing the buoy through Wi-Fi® or Bluetooth® connections.

System 100 further includes an electrical power umbilical 114 and a power cable 116 which sends electricity/power from the station 104 to the at least one buoy 102. System 100 additionally includes a water hose umbilical 118 and water piping 120 which sends desalinated water from at least one buoy 102 to station 104.

At least one buoy 102 produces freshwater from seawater and transports the freshwater from buoy 102 to station 104 through water hose umbilical 118 and water piping 120. Signal umbilical 110, signal cables 112, electrical power umbilical 114 containing a power cable 116, water hose umbilical 118 and water piping 120 are collectively referred to as shore-to sea connections 121. As will be discussed in detail below, buoy 102 utilizes a process, such as a reverse osmosis (RO) process, to remove salt from the seawater to produce the freshwater permeate. Once the freshwater is delivered to station 104, the freshwater will undergo additional post-treatment steps to produce re-mineralized potable water. In one or more embodiments, the desalination buoy 102, shore-to-sea connections 121 and post treatment station 104 act as an integrated system made of modular elements which are uniquely distributed so that desalination occurs in the ocean environment below the ocean surface and only desalinated water is conveyed to the post-treatment station 104 onshore.

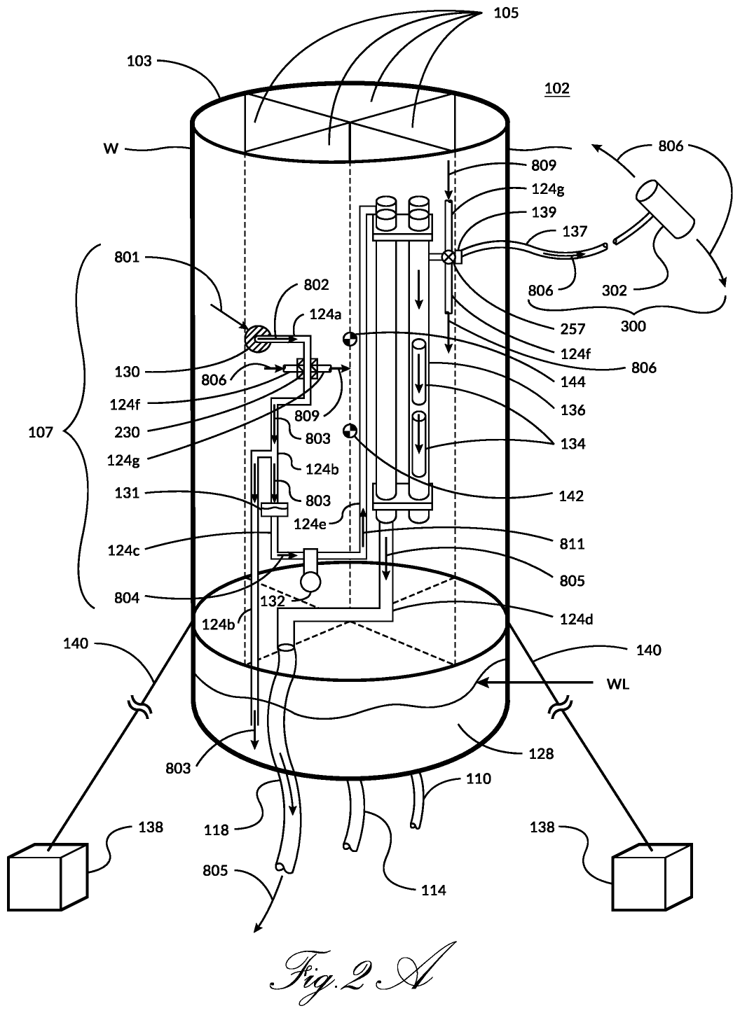

FIG. 2A shows many of the internal components of buoy 102 which are mostly contained within a container vessel 103, including compartments 105, water treatment systems 107 and filtered water holding tank 128. The upper portion of container vessel 103 is divided into two or more vertically oriented, watertight compartments 105, shown in FIG. 2 as four quadrant section compartments. For simplicity, water treatment system 107 is shown only in one quadrant compartment with a substantially identical water treatment system 107 in each of the remaining quadrant compartments 105. Interconnection and placement of components is shown schematically and actual position within the container vessel 103 may vary. Details of example structural implementations are shown subsequently. Raw seawater 801 passes through an intake screen 130 upon first entering buoy 102 to produce screened seawater 802. The screened seawater 802 then travels through intake water piping 124a to an integral media filter 230 to produce filtered seawater 803. A portion of the filtered seawater 803 can be routed through additional distribution water piping 124b to be stored within a filtered seawater holding tank 128 in a lower portion of the container vessel 103 filled to a water level WL as will be discussed in greater detail subsequently. In one or more embodiments, a portion of the filtered seawater 803 travels through a UV disinfection system 131 connected to the distribution water piping 124b to produce filtered, disinfected seawater 804 transmitted through water treatment inlet pipes 124c. The water treatment system 107 additionally includes a high-pressure pump 132 which raises the pressure of filtered, disinfected seawater 804 to produce high-pressure, filtered, disinfected seawater 811 that travels through high pressure water pipe 124c to RO membrane elements 134 stored within vertically oriented RO vessels 136 contained in the vertical compartment. The UV disinfection system 131 avoids the need for chemical disinfection treatment that would otherwise require tankage for chemical storage and replenishment within the container vessel 103.

The RO membranes 134 produce desalinated water 805 which is discharged through outlet piping 124d and brine 806 which is discharged through a brine discharge port 139 or routed through brine index valve 257 and brine return line 124f to integral media filter 230 for backflushing purposes, which backflush outflow 809 may be returned to brine index valve 257 via backflush return line 124g, as will be described in greater detail subsequently. Prior to brine 806 being released back into the water below waterline W, it travels through a brine discharge system consisting of a flexible hose 137 and a roving brine diffuser 300 which will be discussed in detail below. In one or more embodiments, buoy 102 is anchored to the seafloor through one or more anchors 138 that are secured to the buoy 102 by mooring lines 140, which assist in maintaining the position of the buoy 102. In one or more embodiments, the mooring lines 140 include catenary and tension-leg moorings. When in use, the one or more buoys 102 will be oriented vertically such that the center of mass 142 is located below the center of buoyancy 144. The water level WL within holding tank 128 may be varied and thus determine the vertical locations of both the center of mass 142 and the center buoyancy 144.

FIG. 2B indicates the two operating positions of brine index valve 257 as follows: 1) brine flow 806 is passed directly out of brine discharge port 139 with valve ports 4 and 2 being open to each other and valve ports 1 and 3 being closed, or 2) brine flow 806 is circulated back to integral media filter 230 via brine return line 124f to act as backflushing fluid and returned as backflush outflow 809 to brine index valve 257 via backflush return line 124g with valve ports 4 and 3 open to each other and valve ports 1 and 2 open to each other to eject backflush outflow 809 through brine discharge port 139.

Compartments 105 and individual water treatment systems 107 contained within each compartment 105 serve two functions to improve system 100 resiliency by 1) providing isolation of accidental leakage in any compartment 105 from adjacent compartments 105 to prevent vessel 102 flooding and sinking, and 2) providing water treatment resiliency so that if one or more systems 107 fail, the remaining systems 107 can continue to operate.

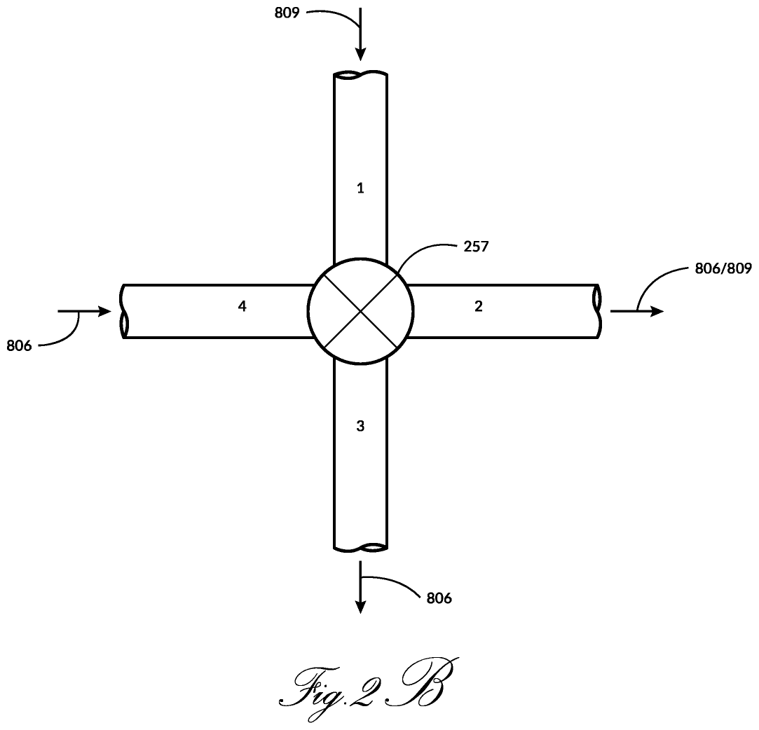

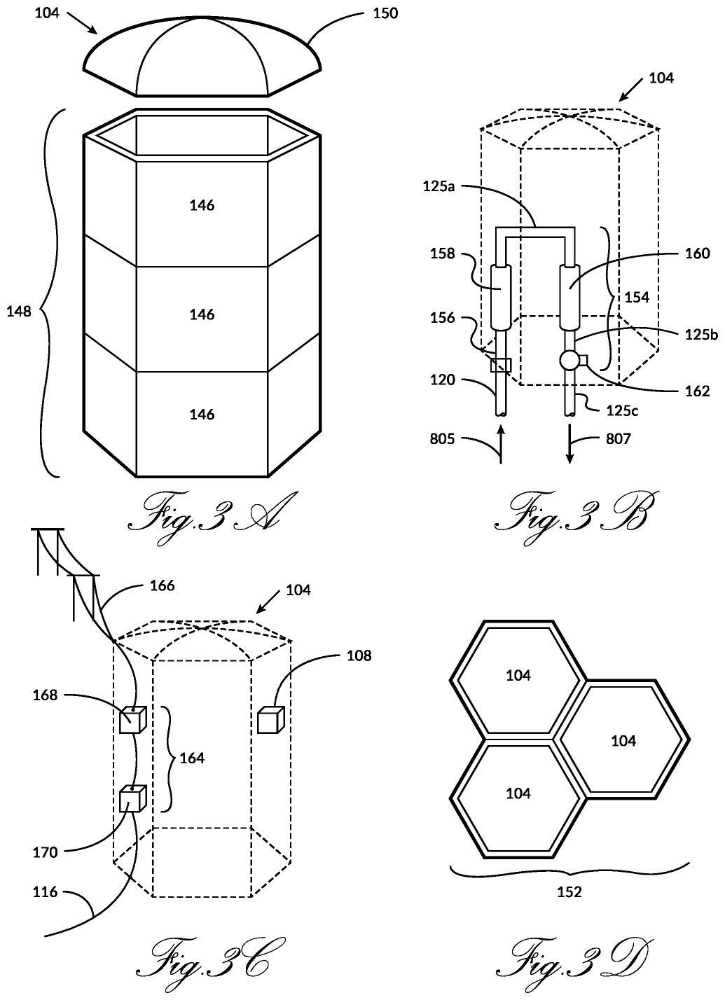

FIGS. 3A-3C show differing views of the shore-based, modular post-treatment station 104 of system 100. Post-treatment station 104 includes both wet and dry post-treatment chemicals, electrical interconnection equipment, telecommunications equipment, data analysis and control equipment, and room for operating personnel. It is contemplated that station 104 can include silos and tanks integrated within the station to house the wet and dry chemicals and a dedicated office space to house any operating personnel. The post-treatment station 104 receives and treats desalinated water 805 from the one or more buoys 102 to meet water quality requirements of the water system receiving the treated water. Post-treatment station 104 includes a plurality of hexagonal ring sections 146 stacked on top of one another to form a singular hexagonal housing 148. Although post-treatment station 104 is shown and described as being hexagonal in shape, any interlocking geometric shape is contemplated. Hexagonal housing 148 is capped with a modular cap 150 to complete the structure of the post-treatment station 104. As shown in FIG. 3D, a plurality of modular post-treatment stations 104 can be replicated and adjoined side-by-side to form a building cluster 152. In one or more embodiments, the hexagonal ring stations 146 are made of reinforced concrete or similar materials. In another embodiment, hexagonal ring sections 146 may be formed in semi-ring sections to facilitate shipping to a post-treatment station 104 site.

The post-treatment station 104 houses post-treatment equipment 154. In one or more embodiments, the post-treatment equipment 154 includes post treatment inlet piping 156 connected to water piping 120 which sends desalinated water 805 from the at least one buoy 102 to the station 104. Post-treatment equipment 154 further includes remineralization equipment 158 connected by process water piping 125a to disinfection equipment 160 which receives the remineralized water. The disinfection equipment 160 is also connected to a circulation pump 162 through internal water piping 125b, which is additionally connected to distribution outlet piping 125c from which post-treated water 807 travels out of station 104. In one embodiment, post-treatment equipment 154 may be pre-assembled in a factory onto a portable frame, creating a modular component that can be shipped to a construction site and inserted through the top of hexagonal structure 148 with a crane, before installing modular cap 150. This modular assembly method can save field construction time and cost relative to assembly of post-treatment equipment 154 on a construction site.

The post-treatment station 104 additionally includes electrical interconnection equipment 164 including line connections 166, switchgear 168, and transformers 170 connected to the power cable 116. Line connections 166 and switchgear 168 provide electricity and switching capabilities for receiving power from an external utility while the transformers 170 will allow for the received electrical power voltage to be modified for supply to the processing buoy 102.

FIG. 4 shows elements of SCADA system 172 that performs as the master controller for system 100 by receiving operational data from buoys 102, analyzing the data to determine system status, and providing control commands to post-treatment station 104 and one or more buoys 102 to adjust the operational status of system 100. The system status perceived by the SCADA system 172 includes the status of the water treatment systems 107, the water quality conditions of inlet seawater 801 surrounding buoy 102, and the maritime status of floating vessel 103 subjected to sea state conditions. Buoy controller 106 and control system 108, connected by signal cables 112 and control signal umbilical 110, are elements of SCADA system 172. Buoy controller 106 additionally includes one or more sensors 174, one or more actuators 176, and a remote-controller 178 with remote-control software 180, all connected by wire and fiber optic signal connectors 182. The control system 108 within the post-treatment station 104 additionally includes controller software 184.

In one or more embodiments, the one or more sensors 174 can include process control sensors to measure pressure, flow, conductivity, turbidity, tank water level within the buoy 102, and temperature for remote-controller 178 to assess the inlet seawater 801 quality and internal water quality at different process stages, as well as system operational status of the water treatment systems 107. These process control sensors can also provide data for remote-controller 178 to assess the fouling status of filter elements 230 and the RO membrane elements 134 stored within RO vessels 136. In one or more embodiments, one or more sensors 174 can include electrical system sensors to measure AC and DC voltage, battery voltage, protective relays, and variable frequency drive status to indicate the condition of the electrical system within the one or more buoys 102. In one or more embodiments, one or more sensors 174 can include tilt and yaw sensors to measure the vertical and horizontal acceleration, pitch, bilge water level, and pneumatic system pressure, which may indicate the maritime operational status of one or more buoys 102. In one or more embodiments, one or more actuators 176 can include pneumatic-driven valves, solenoid-driven valves, and motor-driven valves, variable frequency drives, pump motors, relays, or contactors that operably connected for actuation by the remote-controller 178.

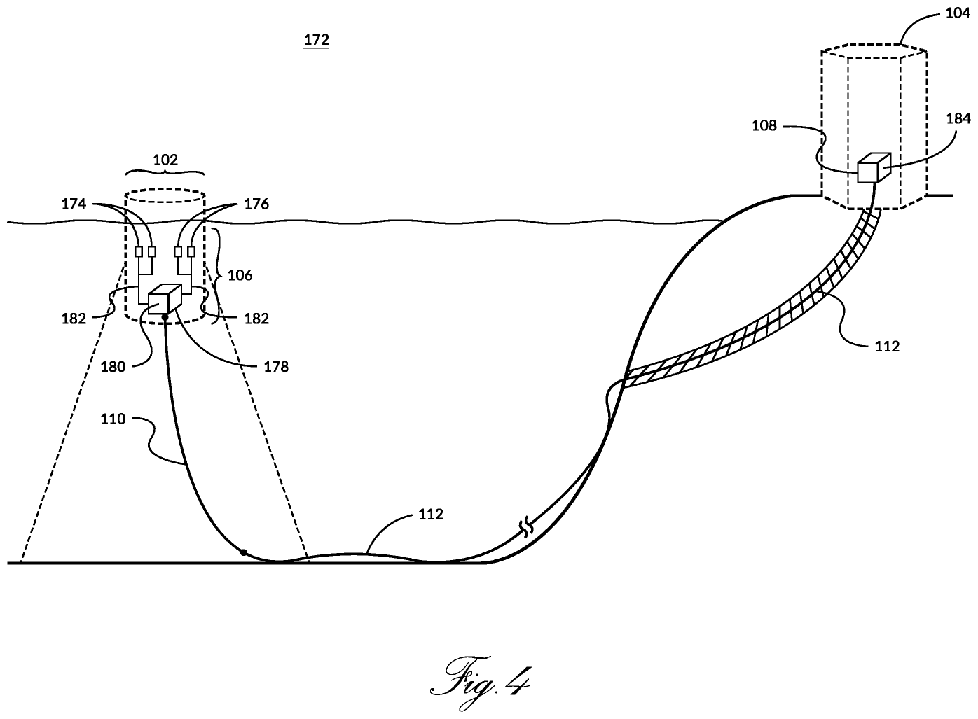

FIG. 5 shows components of a dynamic ballast system 186 of desalination buoy 102. Dynamic ballast system 186 includes filtered water holding tank 128 located in the lower portion of container vessel 103. Water level WL within filtered water holding tank 128 is indicated through a level sensor 190 connected to a remote-controller 178 in the buoy controller 106 through sensor cable 192. Remote-controller 178 sends control signals to outlet pump 132 and inlet pump 194 via signal cables 196 to regulate inflows IF and outflows OF of filtered seawater 803 within the filtered water holding tank 128 from the distribution water piping 124b. Dynamic motions of container vessel 103 are measured with one or more 3-axis accelerometers/gyroscopes 198 connected to the remote-controller 178 by signal cables 196. The remote-control software 180 residing within remote-controller 178 analyzes input signals coming from the one or more 3-axis accelerometers/gyroscopes 198 and the level sensor 190 to generate command signals to send to the outlet pump 132 and inlet pump 194.

In one or more embodiments, the remote-control software 180 regulates dynamic ballast system 186 by adjusting the water level WL and the corresponding ballast volume V of water within filtered water holding tank 128 using level sensor 190 and the outlet pump 132 and inlet pump 194. The total inlet flow rate of filtered seawater 803 from filter 230, the volume V of water within filtered water holding tank 128, and the inflow IF and outflow OF flow rates will regulate flows of filtered seawater 803 for 1) intake into the RO membrane elements 134 stored within RO vessels 136, 2) backflushing of filter 230 (discussed below), and 3) the retention of filtered seawater 803 within the ballast system 186 to act as the ballast volume V.

In one or more embodiments, the remote-control software 180 in the controller 106 regulates the dynamic ballast system 186 by adjusting the water level WL to provide water mass tuning of the buoy 102 by increasing or reducing the ballast volume V, thus reducing or increasing the buoy's 102 natural frequency. The volume V and its associated mass may be adjusted to detune the natural frequency of buoy 102 relative to the excitation frequency of ocean waves by the first order relationship F=\sqrt{k/M}, where F is buoy 102's natural frequency, k is the spring constant (i.e. displacement reaction of buoy 102) and M is the total mass of buoy 102. For example, by increasing volume V and thus mass M (while keeping k constant), the natural frequency F of buoy 102 can be reduced and may be reduced below the ocean wave frequency during a certain sea condition. By reducing natural frequency F, harmonic excitation and extreme motions of buoy 102 may be avoided in the heave, pitch, and roll directions, driven by the wind and waves surrounding buoy 102.

Dynamic ballast control is accomplished by measuring water level in a filtered seawater holding tank in a lower portion of a container vessel to define a ballast volume and sensing an excitation frequency f of waves in water surrounding the buoy. Detuning a natural frequency F of the buoy is accomplished by operating one of the inlet pump 194 and the outlet pump 132 operably connected to the filtered seawater holding tank to alter F defined as F=√(k/M) where k is the spring constant defined by displacement reaction of the buoy and M is the total mass of the buoy and M is proportional to the ballast volume such that F is less than f.

In one or more embodiments, controller software 184 within control system 108 of post-treatment station 104 provides master commands to remote-control software 180 to operate system 100 as a complete water production system, including monitoring of system status through the one or more sensors 174 and commanding one or more actuators 176 to adjust system parameters. In one or more embodiments, the system parameters include initiating backflushing cycles, the sequencing of filter cartridge banks, initiating start-up sequences, initiating shut-down sequences, flagging and responding to fault conditions, and adjusting ballast volume V to reduce harmonic motion of buoy 102.

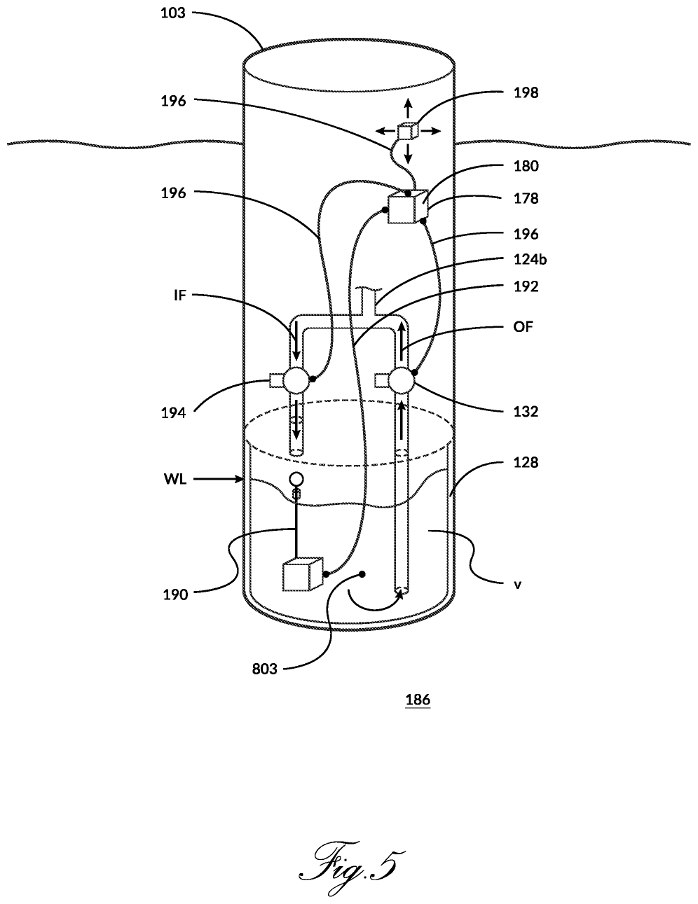

FIG. 6A-6C shows various embodiments of the reverse osmosis components of the water treatment systems 107 of the present disclosure. As shown in FIG. 6B, the reverse osmosis components include a plurality of RO pressure vessel magazines 200, each consisting of a plurality of RO pressure vessels 136 containing RO membrane elements 134. In one or more embodiments, pressure vessel magazines 200 includes support framework, piping and manifold connections, electronic sensors, and wiring. In one or more embodiments, pressure vessel magazines 200 contain a plurality of RO pressure vessels 136 each containing RO membrane elements 134 arranged 2-by-2, 3-by-3, 4-by-4, or other groupings such that multiple magazines 200 in a buoy 102 are sufficient to provide necessary water processing flowrate and efficiently utilize the cylindrical space within the container vessel 103 to minimize its outside diameter. Additionally, FIG. 6C shows vertical compartments 105, which are exist in all embodiments but are not shown in FIGS. 6A, 6B and 6D for graphic simplicity.

Magazines 200 are contained within vertical compartments 105, typically arranged so that one magazine 200 resides in each compartment 105 and configured to be easily installed/removed from container vessel 103 by lifting vertically as a single unit. Each magazine 200 is arranged with minimal structural and piping connection/disconnection points and with such points configured to be readily disconnected, including high pressure feed water input, desalinated water discharge and brine discharge lines. Magazines 200 are configured such that once removed from container vessel 103, magazine 200 may be turned horizontally and moved to a suitable shipboard or onshore location where pressure vessels 136 may conveniently be disassembled for servicing and replacement of RO membrane elements 134. Magazines 200 are configured to reduce operational downtime such that new or previously serviced magazines 200 may be inserted into container vessel 103 to replace magazines 200 that have been removed for servicing.

Each RO pressure vessel magazine 200 also includes a crane attachment means 202 near the longitudinal center of mass of each pressure vessel magazine 200. Crane attachment means 202 groups the plurality of RO pressure vessels 136 together while also providing a point of attachment for a crane cable CC of a crane C, as shown in FIG. 6D, to remove/install a pressure vessel magazine 200 if needed. In one or more embodiments, each pressure vessel magazine 200 is placed within one of a plurality of hatches 204 in the top portion of container vessel 103 of buoy 102. As shown in FIG. 6A, in one or more embodiments, each hatch 204 may be sealed with a hatch cover 206. In one or more embodiments, hatches 204 align with a magazine 200 within said hatch 204 in a one-to-one ratio, thus providing access to each magazine 200 without needing to access other magazines 200. As shown in FIG. 6A, hatch covers 206 can be hinged securely to the top portion of container vessel 103. In one or more embodiments, additional equipment and personnel attain access through one or more additional, central hatch openings (not shown). As shown in FIG. 6C, in one or more embodiments, container vessel 103 contains a single hatch 204 equipped with a single hatch cover 206 and crane lifting point 208 to assist in removing the single hatch cover. The single hatch 204 is used to access and remove/install the pressure vessel magazines 200. In one or more embodiments, a secondary, one or more personnel hatches (not shown) are present, allowing personnel access to container vessel 103 without the necessity of opening large circular hatch cover 206.

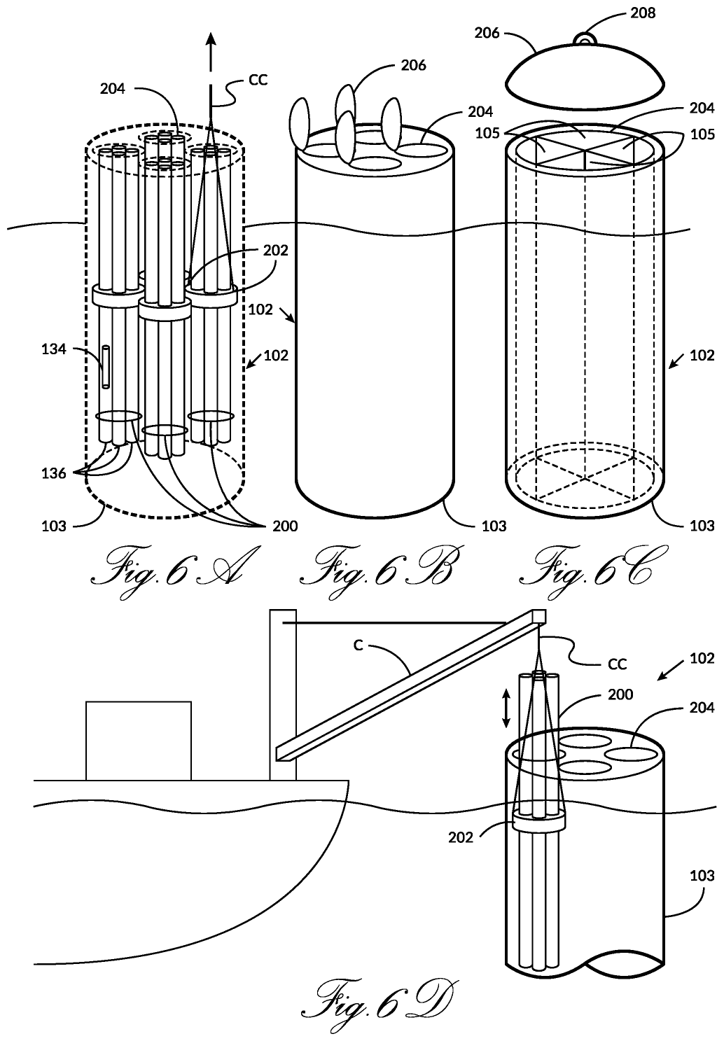

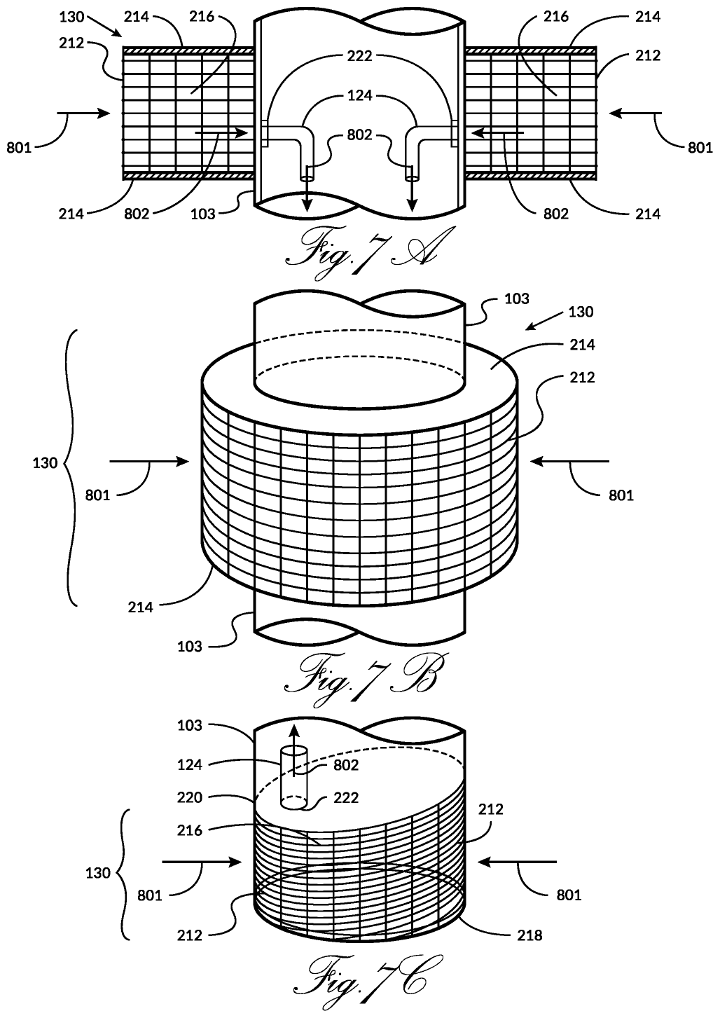

FIG. 7A-7C shows various embodiments of integral intake screen 130 of desalination buoys 102 of the present disclosure. Integral intake screen 130 is configured to enclose and isolate an interior space from a surrounding seawater environment subject to communication of seawater through one or more screen surfaces 212. Integral intake screen 130 is formed as a three-dimensional body consisting of a plurality of plate surfaces 214, including one or more port openings 222 for the purpose of withdrawing seawater from interior space 216, and permeable screen surfaces 212. Such screen surfaces 212 are comprised of a multitude of wedge-profile wire members arranged longitudinally side-by-side with a prescribed, uniform gap between them and attached to perpendicular support bars to form a permeable surface for the purpose of allowing the passage of seawater while restricting the passage of particles, solids, marine organisms or other objects suspended in surrounding seawater. In one or more embodiments, permeable screen surfaces 212 are made of a Copper-Nickel alloy or other material that discourages metal corrosion and biological fouling.

As shown in FIGS. 7A and 7B, in one embodiment, integral intake screen 130 consists of permeable screen sections 212 and impermeable plate sections 214 wrapped around a middle portion of container vessel 103 to create an interior space 216 containing screened seawater 802. This configuration of intake screen 130 utilizes the outer wall structure of vessel 103 to provide an inner wall partition for intake screen 130 and associated structural support. As shown in FIG. 7C, in one embodiment, integral intake screen 130 includes a cylindrical screen 212 section and a bottom plate 218 affixed to a bottom end plate 220 of container vessel 103 allowing raw seawater 801 to pass through gaps in the screen 212 to prevent suspended objects, materials, or marine organisms larger than the gap size from passing through.

Screened seawater 802 is extracted from interior space 216 through port 222 leading into distribution water piping 124a. Alternatively, the intake screen of FIGS. 7A and 7B may utilize the cylindrical screen 212 surrounding the container vessel 103 and be capped on top and bottom with plate sections 214 with screened seawater 802 passing into interior space 216 and withdrawn into distribution water piping 124a through ports 222. In one or more embodiments, to remediate biological fouling of the permeable screen surfaces 212, permeable screen surfaces 212 may be cleaned by technician divers utilizing brushes and manual tools (not shown). In one or more embodiments, the permeable screen surfaces 212 may be cleaned by an integral, motor-driven rotating brush system (not shown) mounted a pair of circular rails or by other means to traverse the outer perimeter of the permeable screen surfaces 212 and scour away marine organisms affixed to the permeable screen surfaces 212, that may be activated periodically to affect a “cleaning-cycle”. In one or more embodiments, permeable screen surfaces 212 may be cleaned by un-mounting the permeable screen surfaces 212 and retrieving to the ocean surface for cleaning.

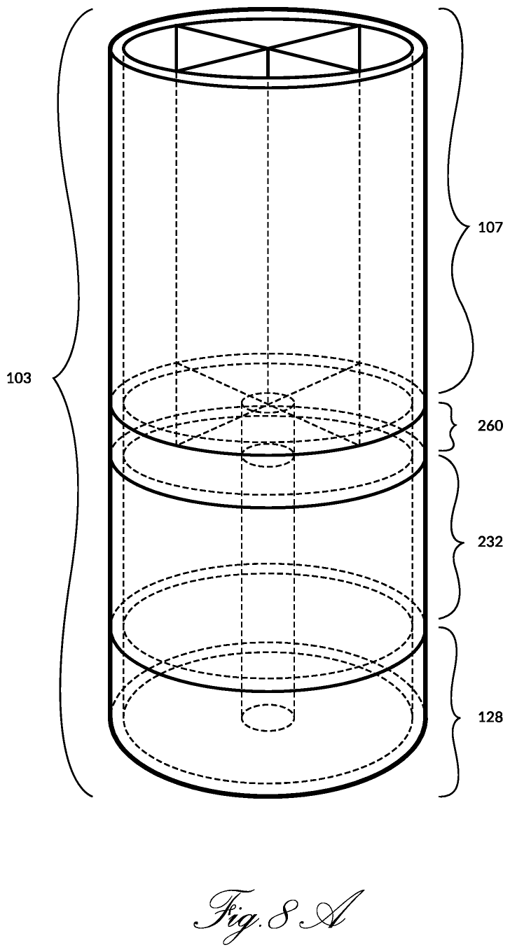

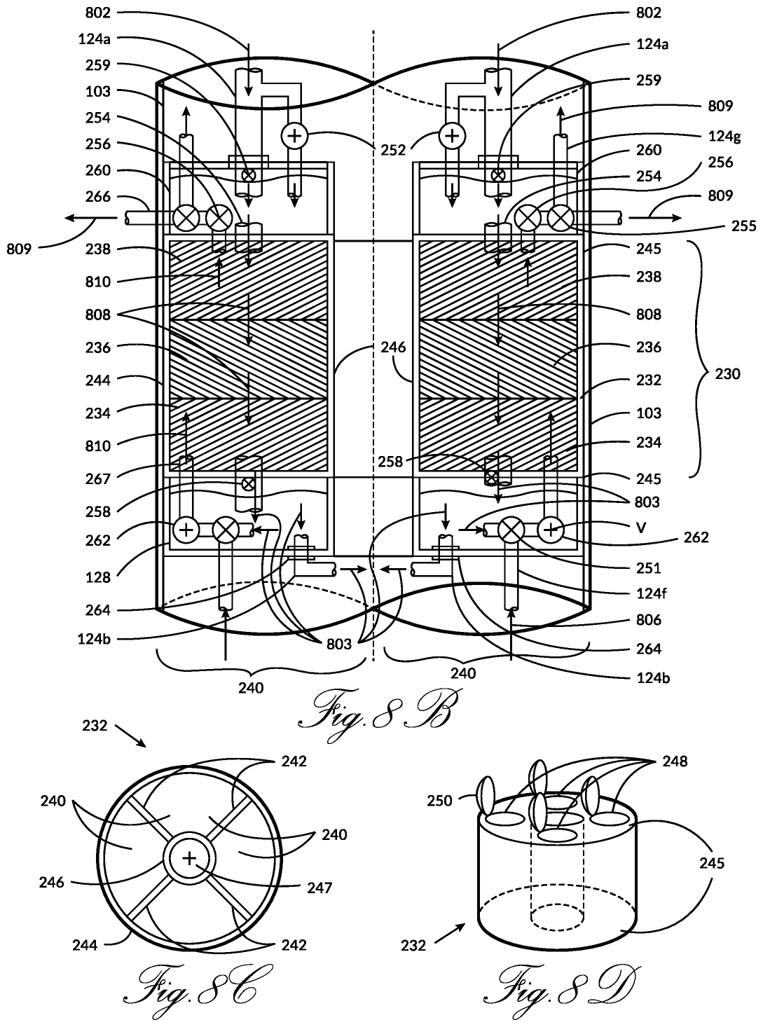

FIG. 8A shows a position of filter vessel 232 within container vessel 103 relative to water treatment system 107, pressurizing tank 260 and holding tank 128. FIGS. 8B, 8C, and 8D show components of integral media filter 230 of desalination buoy 102. Integral media filter 230 is located upstream of high-pressure pump 132 to remove turbidity and solids and particles that remain suspended in seawater 802 after passing though integral intake screen 130. Integral media filter 230 consists of a segmented annular cylindrical media filter vessel 232 fitted inside the container vessel 103, including annular top and bottom plates 245 filled with filter media in discrete layers with a plurality of media materials, such as, but not limited to, gravel 234, sand, 236, and anthracite 238. In one or more embodiments, media filter vessel 232 is subdivided into a plurality of vertically oriented compartments 240 with plates 242 fitted between the outside wall 244 and inside wall 246 of vessel 232. Inside wall 246 forming a central cylindrical passage 247. In one or more embodiments, the plurality of compartments 240 are accessible through hatches 248 and hatch covers 250. Media filter 230 further includes a forward pump 252 connected to screened seawater piping 124a feeding a pressurizing tank 260, a filter inlet port 254 exits the pressurizing tank 260 into the filter media. Discharge valves 256 exit the compartments and are connected to backwash ports 266 extending through walls of the filter vessel 232 and container vessel 103. Forward valves 258 connect the filter media with holding tank 128 and backflush valves 259 connect the pressurizing tank 260 with distribution lines 124a. Backwash pumps 262, filtered seawater supply ports 264, backwash inlet ports 266 and 267 are connected for operation as will be described subsequently,

Media filter vessel 232 is mounted to, or integral with, container vessel 103 and aligned collinearly with the central axis of vessel 103. Media filter vessel 232 receives screened seawater 802 from pressurizing tank 260 and delivers filtered seawater 803 into filtered water holding tank 128. In one embodiment, forward flow through media filter 230 is enabled by closing the discharge valve 256, opening the forward valve 258, closing backflush valve 259, and energizing forward pump 252 to pressurize pressurizing tank 260 and drive the screened seawater 802 into integral media filter 230, becoming filter flow 808, passing through integral media filter 230 and then becoming filtered seawater 803 delivered into holding tank 128 through forward valve 258. Central cylindrical passage 247 allows transition of distribution water piping 124b from holding tank 128.

In another embodiment, forward flow through the media filter 230 is enabled by closing discharge valve 256, opening forward valve 258, opening backflush valve 259 and pressurizing pressurizing tank 260 with hydrostatic pressure existing in screened seawater piping 124a that drives screened seawater 802 through filter inlet port 254, in turn driving the filter flow 808 through integral media filter 230 and delivering filtered seawater 803 into holding tank 128, which is connected to surface air pressure (not shown). Hydrostatic pressure results from locating the media filter 230 at a depth below the water surface within container vessel 103 whereby differential pressure between pressurizing tank 260 and holding tank 128 drives filter flow 808.

In another embodiment, reverse flow through medial filter 230 is enabled to allow filtered water volume V in the holding tank 128 to be utilized for “backflushing” of the filtration materials by opening discharge valve 256, closing forward valve 258, closing backflush valve 259, indexing two-position valve 251 to intake filtered seawater 803 from holding tank 128, and energizing backflush pump 262 to drive backflush flow 810 from port 267 towards discharge port 266 so that water and materials removed from the media filter 230 during backflushing are discharged into the surrounding seawater.

In another embodiment, brine flow 806 is used as the backflushing fluid by indexing two-position valve 251 to intake brine flow 806 from brine return line 124f, substituting filtered seawater 803 from holding tank 128. In this case, brine 806 is pumped through backflush pump 262 to produce backflush flow 810, which is discharged as backflush outflow 809 through backflush return line 124g through brine index valve 257 to the brine discharge port 139, instead of discharge port 266. Increased salinity of brine 806 as a backflushing fluid may contribute to reduced biofouling in media filter 230.

In one or more embodiments, media filter vessel 232 is divided into compartments 240 with a multiplicity of radially oriented plates 242 connecting the inner 246 and outer 244 tank walls, creating discrete filter elements within the filter vessel 232. This divisional allows for operating and backflushing of individual compartments 240 to reduce backflushing flow rate requirements by compartmentalizing into smaller filters sections, allow filtered seawater 803 or brine flow 806 produced by other compartments 240 to be directed to backflushing without the need for a large backflushing water storage capacity in holding tank 128 or other storage tank for brine flow 806, and allowing for sequential compartment 240 backflushing while maintaining sufficient filtration flow to avoid interrupting the RO desalination process.

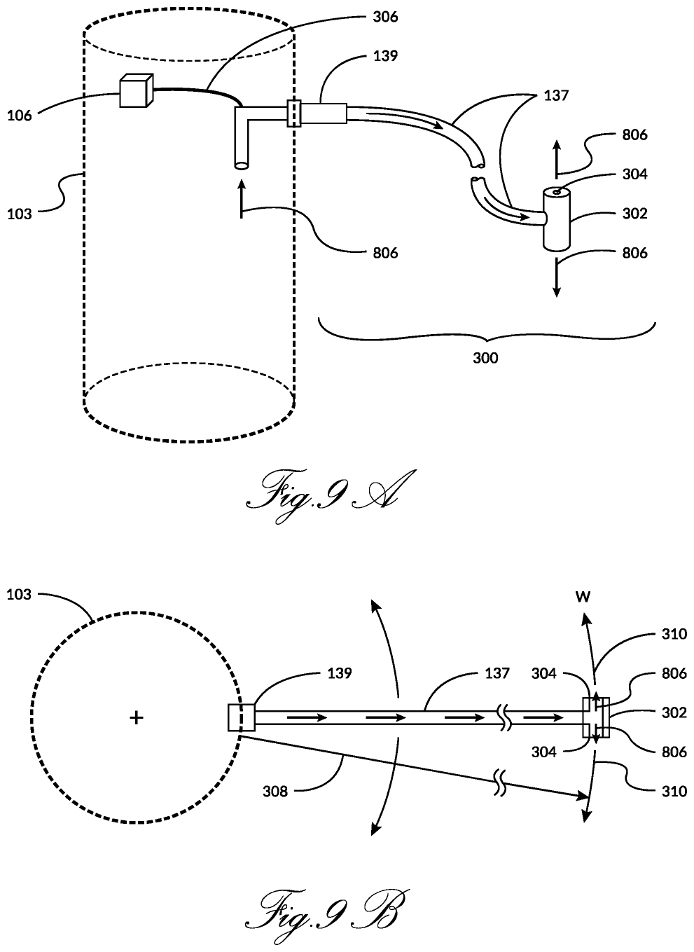

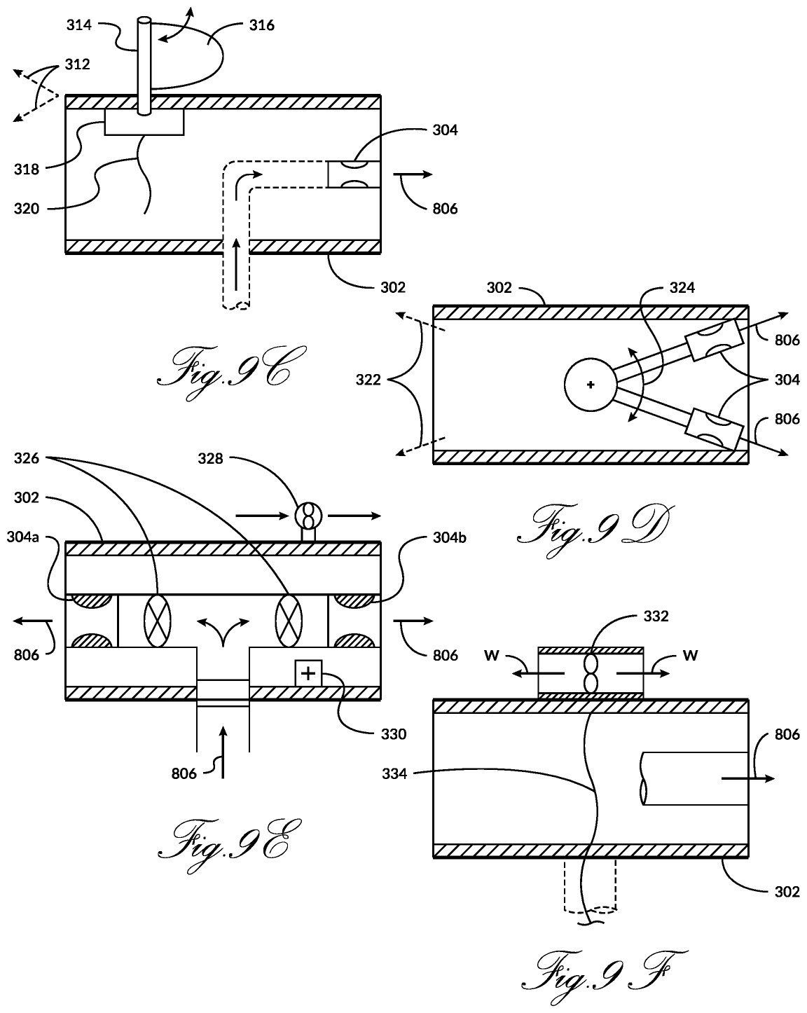

FIG. 9A shows components of the roving brine diffuser system 300 including brine discharge port 139 in container vessel 103 connected to a flexible brine hose 137. Brine hose 137 is connected to a discharge thruster device 302 floating in seawater surrounding the container vessel where brine 806 (or backflush outflow 809, hereafter referred interchangeably to as brine flow 806) is discharged into the surrounding water through a discharge nozzle 304 of discharge thruster device 302. Discharging takes place at a distance from container vessel 103 determined by length of hose 137 and positioning of discharge thruster device 302. Roving brine diffusor system 300 is connected to remote-controller 106 via a signal cable 306 to control the discharging of brine 806 through the system 300.

FIG. 9B shows how system 100 operates to safely discharge brine 806. Discharge thruster device 302 follows a horizontal arc 310 determined by a radial length 308 of flexible hose 137 while ejecting brine 806 through nozzle 304. The one or more nozzles 304 accelerate the exiting brine 806 for the purposes of localized mixing of the brine 806 with surrounding seawater W while also providing thrust to drive the discharge thruster device 302 horizontally and vertically in the surrounding seawater W. Discharge thruster device 302 is therefore configured so that outflowing brine 806 is discharged into volumes of seawater W accessed by movement of device 302 within radius 308 of the container vessel 103 rather than at a static point, acting in a similar manner to an ocean current passing by a fixed discharge point.

FIG. 9C shows an embodiment of the present disclosure wherein discharge thruster device 302 follows a horizontal arc 310 as it adjusts vertical position in the water column indicated by trajectories 312. Trajectories 312 are determined by a rotary position of a drive shaft 314 attached to a control surface 316 creating vertical lift as driven by a positioning motor 318 connected to a control wire 320 while ejecting brine 806 through one or more nozzles 304.

FIG. 9D shows an embodiment of the present disclosure wherein nozzle 304 is pivotable and the discharge thruster device 302 follows trajectories 322 in a vertical plane to establish the depth of thruster device 302 as determined by a pivoting position 324 of nozzle 304 while ejecting brine 806 through nozzle 304. Buoy controller 106 (not shown) can also actively position nozzles 304 relative to the body of device 302 to determine the direction of travel of device 302.

In one or more embodiments and as shown in FIG. 9E, discharge thruster device 302 follows opposing arc directions 310 while utilizing two opposing nozzles 304a and 304b with control valves 326 determining binary flow direction with one valve 326 open and one valve 326 closed while ejecting brine 806 through one nozzle 304a or 304b. In one or more embodiments, to assist with discharging of brine 806, discharge thruster device 302 is equipped with flow a velocity sensor 328 and global positioning sensor 330.

In one or more embodiments and as shown in FIG. 9F, discharge thruster device 302 utilizes a driven marine thruster 332 powered from a power cable 334 to accelerate through the surrounding seawater W to drive its position instead of by ejecting brine 806 through nozzle 304 at medium or high velocity, allowing the bring 806 to be dispersed at a low velocity into the surrounding seawater W.

In one or more embodiments, device 302 is configured to be actively controlled with sensor signals, such as velocity sensor 328 and global positioning sensor 330, generated on the device 302 and control signals received by the device 302 through a control cable (not shown) passing through the flexible hose 137, or by radio signal communication received from buoy controller 106. Buoy controller 106 commands the depth and direction of travel of the device 302 so that it may be moved within seawater W.

In one or more embodiments, nozzles 304 maintain a fixed position relative to the body of device 302 and utilize one or more actively controlled hydrodynamic control surfaces 316 affixed to a drive shaft 314 rotated by a positioning motor 318 in response to position signals from buoy controller 106 to determine vertical trajectories 312 of device 302 and the resulting depth of the device 302.

In one or more embodiments, the device 302 employs electrical power fed by a power cable 334 within the flexible hose 137 from the container vessel 103 to power marine thruster 332 utilized to create motion of the device 302 rather than thrust derived from the nozzles 304. Such an electric thrust device 332 may apply thrust in two opposite directions to determine the direction of travel of the device 302.

In one or more embodiments, the device 302 utilizes nozzles 304 pointing in opposing directions within the device 302 aligned with the arc of travel 310 with control valves 326 directing flow to one nozzle 304a or the other nozzle 304b depending on the desired direction of travel.

In yet another embodiment, device 302 is in not actively controlled and is intended to move in a random pattern resulting from the positions of the nozzles 304 relative to the body of device 302, the location of the discharge port 139 on container vessel 103, and the length and stiffness of the hose 137.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the disclosure to be defined by the claims appended hereto.

1. A modular water desalinization system (MWDS) comprising:
at least one processing buoy having
a container vessel with a plurality of compartments;
an intake screen connected through intake water piping to a water filter connected to each of the plurality of compartments providing filtered water to distribution water piping;
a filtered water holding tank connected to the distribution water piping;
a plurality of water treatment systems, one of the plurality of water treatment systems supported in each of the plurality of compartments and comprising
a plurality of Reverse Osmosis (RO) membrane elements stored in vertically oriented RO vessels connected to the filtered water holding tank through treatment inlet water pipes;
a brine discharge port connected to the RO vessels to discharge brine;
outlet piping connected to the RO vessels to receive desalinated water;
a high pressure pump connected to the distribution pipes for water pressurization in the treatment inlet water pipes;
a buoy controller operably connected to the high pressure pump;
at least one modular post treatment station having
a plurality of stacked ring sections interconnected to form a housing;
post treatment equipment housed within the housing and having inlet piping, the post treatment equipment producing post treated water;
distribution outlet piping connected to the post treatment equipment for output of post treated water for use;
a control system connected to the buoy controller, the control system configured to instruct operation of the high pressure pump responsive to water demand;
a water hose umbilical connecting the outlet piping to the inlet piping; and
an electrical power umbilical having a power cable and connecting the control system to the buoy controller.

2. The MWDS as defined in claim 1 wherein each water treatment system further includes a UV disinfections system connected to the treatment inlet water pipes.

3. The MWDS as defined in claim 1 wherein the post treatment equipment comprises:
remineralization equipment connected to process water piping providing re-mineralized water;
disinfection equipment receiving the re-mineralized water through the process water piping;
a circulation pump connected to the disinfection equipment through internal water piping and connected to distribution outlet piping from which post-treated water travels out of the post treatment station.

4. The MWDS as defined in claim 1 wherein the modular post treatment station further comprises:
electrical interconnection equipment including line connections, switchgear, and transformers connected to the power cable.

5. The MWDS as defined in claim 1 wherein the stacked ring sections of the modular post treatment station comprise interlocking geometrical cross sections.

6. The MWDS as defined in claim 1 wherein the housing further comprises a modular cap.

7. The MWDS as defined in claim 1 wherein the control system and the buoy controller cooperatively form a Supervisory Data Acquisition and Control (SCADA) system wherein the buoy controller further comprises one or more sensors, one or more actuators, and a remote-controller with remote-control software, said one or more sensors comprising process control sensors to measure pressure, flow, conductivity, turbidity, tank water level within the buoy, and temperature for remote-controller to assess the inlet seawater quality and internal water quality at different process stages, as well as system operational status of the plurality of water treatment systems.

8. A processing buoy for water desalinization comprising:
a container vessel having a plurality of watertight vertical compartments in an upper portion;
a water treatment system contained in each of the vertical compartments and having
intake water piping connected to an integral media filter producing filtered seawater;
distribution water piping receiving the filtered seawater;
an ultraviolet (UV) disinfection system connected to the distribution water piping to receive the filtered seawater and producing disinfected seawater for output through water treatment inlet piping;
a high pressure pump connected in the water treatment inlet piping to pressurize the disinfected seawater producing pressurized disinfected seawater into a high pressure water pipe;
a plurality of vertically oriented Reverse Osmosis (RO) vessels stored within the vertical compartment and containing RO membrane elements, each of the vertically oriented RO vessels connected to the high pressure water pipe to receive the pressurized disinfected seawater, and each of the vertically oriented RO vessels connected to outlet piping for discharge of desalinated water and connected to a brine discharge port;
a filtered seawater holding tank in a lower portion of the container vessel and connected to receive filtered seawater from the distribution water piping through an inlet pump and return filtered seawater to the distribution water piping through an outlet pump, said filtered seawater holding tank filled with filtered seawater to a water level calculated to determine the vertical locations of both the center of mass and the center buoyancy of the container vessel; and
a controller operably connected to the high pressure pump to control desalinated water discharge, the controller further configured to calculate the water level and operably connected to the inlet pump and outlet pump.

9. The processing buoy of claim 8 wherein the buoy controller further comprises one or more sensors, one or more actuators, and a remote-controller with remote-control software, said one or more sensors comprising process control sensors to measure pressure, flow, conductivity, turbidity, tank water level within the buoy, and temperature for the remote-controller to assess the inlet seawater quality and internal water quality at different process stages, as well as system operational status of the plurality of water treatment systems.

10. The processing buoy of claim 9 wherein the one or more actuators comprise pneumatic-driven valves, solenoid-driven valves, motor-driven valves, variable frequency drives, pump motors, relays or contactors operably connected for actuation by the remote-controller.

11. The processing buoy of claim 9 further comprising a dynamic ballast system, the dynamic ballast system comprising a tank water level sensor in the filtered seawater holding tank connected to the remote controller and wherein the remote controller is configured to calculate a desired ballast volume to provide mass tuning of a natural frequency of the buoy and operate the inlet pump and outlet pump to adjust water level to provide the desired ballast volume.

12. The processing buoy of claim 11 wherein the ballast volume is calculated to detune a natural frequency F of the processing buoy defined as F=\sqrt{k/M}, where k is the spring constant defined by displacement reaction of the buoy and M is the total mass of the buoy and M is proportional to the ballast volume.

13. A method for dynamic ballasting of a processing buoy for water desalinization, the method comprising:
measuring water level in a filtered seawater holding tank in a lower portion of a container vessel to define a ballast volume;
sensing a frequency of oscillation f of waves in water surrounding the buoy;
detuning a natural frequency F of the buoy by operating one of an inlet pump and an outlet pump operably connected to the filtered seawater holding tank to alter F defined as F=\sqrt{k/M} where k is the spring constant defined by displacement reaction of the buoy and M is the total mass of the buoy and M is proportional to the ballast volume such that F is reduced to a frequency less then f.

14. A roving brine diffuser system for use with a desalinization processing buoy, the roving brine diffuser system comprising:
a brine discharge port in a container vessel;
a flexible brine hose connected to the brine discharge port;
a discharge thruster device connected to the flexible brine hose distal from the discharge port and floating in seawater surrounding the container vessel, the discharge thruster having a discharge nozzle to eject brine thereby providing thrust to drive the discharge thruster device relative to the container vessel.

15. The roving brine diffuser system defined in claim 14 wherein the discharge thruster device follows a horizontal arc determined by a radial length of the flexible hose while ejecting brine through the discharge nozzle.

16. The roving brine diffuser system as defined in claim 14 wherein the discharge thruster device further comprises a drive shaft attached to a control surface, said discharge device adjusting vertical position responsive to a rotary position of the drive shaft creating vertical lift in the control surface while ejecting brine from the discharge nozzle.

17. The roving brine diffuser system of claim 16 wherein the discharge thruster device further comprises a positioning motor connected to a control wire operatively engaged to a controller configured to select a trajectory based on thrust of the discharge nozzle and lift of the control surface.

18. The roving brine diffuser system of claim 15 wherein the discharge thruster device wherein the discharge nozzle is pivotable and the discharge thruster device follows trajectories in a vertical plane to establish the depth of thruster device as determined by a pivoting position of nozzle while ejecting brine through nozzle.

19. The processing buoy of claim 8 wherein the integral media filter comprises:
a segmented media filter vessel fitted inside the container vessel and including annular top and bottom plates divided into compartments with a multiplicity of radially oriented plates connecting an inner tank wall and outer tank wall, creating discrete filter elements within the filter vessel, the filter elements filled in discrete layers with a plurality of media materials, such as, but not limited to, gravel, sand, and anthracite, the segmented media filter vessel configured to allow individual operating and backflushing of the compartments to reduce backflushing flow rate requirements by compartmentalizing into smaller filters sections, allow filtered seawater produced by other compartments to be directed to backflushing without the need for a large backflushing water storage capacity in the holding tank, and allow for sequential compartment backflushing while maintaining sufficient filtration flow to avoid interrupting the RO desalination process.

20. The processing buoy of claim 19 wherein brine is pumped through a brine return line through backflush pump to produce backflush flow, which is discharged through a backflush brine line 124g to the brine discharge port.
